(19) United States
(12) Patent Application Publication
(10) Pub. No.: US 2014/0257755 A1
(43) Pub. Date: Sep. 11, 2014

(54) Method for Reconstructing Signals from Phase-Only Measurements

(71) Applicant: MITSUBISHI ELECTRIC RESEARCH LABORATORIES, INC., (US)

(72) Inventor: Petros T. Boufounos, Boston, MA (US)

(73) Assignee: MITSUBISHI ELECTRIC RESEARCH LABORATORIES, INC., Cambridge, MA (US)

(21) Appl. No.: 13/794,043

(22) Filed: Mar. 11, 2013

(51) Int. Cl. G06F 17/10

(52) U.S. Cl. CPC G06F 17/10
USPC 702/189

(57) ABSTRACT

A signal is reconstructed by first producing complex-valued measurements of the signal by measuring the signal using a linear complex measurement system, and retaining only a phase of the complex-valued measurements. Then, the signal is reconstructed from the phase of the complex measurements within a scaling factor using a sparse reconstruction method.

### RELATED APPLICATION

This application is related to U.S. patent application Ser. No. 13/792,356 entitled “Method for Angle-Preserving Phase Embeddings,” co-filed herewith, and incorporated herein by reference. Both applications relate to sparse representations of phases of signals and compressive sensing.

### FIELD OF THE INVENTION

This invention relates generally to signal processing, and more particularly to reconstructing sparse signals from only phases of the signals.

### BACKGROUND OF THE INVENTION

The advent of compressive sensing (CS) has significantly improved the ability to sense a variety of signals. Conventional CS theory indicates that it is possible to acquire signals at a rate dictated by the complexity of the signal model, rather than the signal dimensionality. The acquisition is performed using incoherent measurements that preserve all information in the signal. The signal can be reconstructed from those measurements by exploiting a signal model such as sparsity. Thus, it is possible to simplify sensing systems in a number of applications by substitute inexpensive computational complexity in place of frequently expensive sampling complexity.

Conventional CS makes it possible to measure and successfully reconstruct a signal that is sparse, in some basis, using a number of linear measurements, which is approximately proportional to a small number of non-zero components of the signal in that basis. This acquisition can be expressed as a linear system

y=Ax, (1)

where x denotes the sparse signal, y denotes the measurements, and A denotes a measurement matrix representing the linear system. The dimensionality of the signal is M×N, where M denote the dimensionality of the data, and N the dimensionality of the acquired signal. The sparsity of, i.e., the number of non-zero coefficients, is denoted using K. Without loss of generality, the signal is sparse in a canonical basis.

A sufficient condition to reconstruct the signal from the measurements, is the Restricted Isometry Property (RIP). That is, the matrix A satisfies the RIP of order K, with the RIP constant δ_{K}, if for all K-sparse vectors:

(1−δ_{K})∥x∥₂≦∥Ax∥₂≦(1+δ_{K})∥x∥₂, (2)

i.e., approximately preserves the norm of all K-sparse vectors. Thus, a matrix satisfying the RIP of order 2K describes an embedding of K-sparse vectors in N dimensions into an M-dimensional space. This embedding preserves the l₂ distance.

If the RIP of order 2K holds with a small RIP constant, then the signal can be exactly recovered using the convex program

$$\hat{x} = arg {min}_{x} {‖ x ‖}_{1} s . t . y = Ax , \qquad ( 3 )$$

or a greedy process. Variations of this program, as well as the recovery guarantees, have been developed for a variety of measurement noise conditions and relaxations of the strict sparsity requirement.

The RIP has been established for a variety of matrix classes. With high probability, a properly scaled random matrix with entries generated from an i.i.d. normal or sub-Gaussian distribution satisfies the RIP as long as M=O(K log N). Similar results have been shown for other matrices, such as matrices generated by randomly sampling rows of a discrete Fourier transform (DFT) matrix.

1-Bit Compressive Sensing

Practical acquisition systems quantize the measurements. One system uses 1-bit CS to quantize to one bit per measurement, i.e., preserving only the sign of each measurement:

y=sign(Ax), (4)

where (•) is applied element-wise to the argument. Because sign(Ax)=sign(Acx), for all c>0, 1-bit CS acquisition eliminates amplitude information about the signal. Thus, one can only hope to recover the signal within a scaling factor. Furthermore, the solution of an l₁ minimization program similar to equation (3) degenerates to a zero x. Some way to enforce a norm constrain is necessary. The conventional constraint ∥x∥₂ leads to non-convex program, difficult to analyze.

A convex program can be formulated if one exploits the fact that the sign measurements of the signal reveal the quadrant in which the measurements lie. Thus, a linear constraint can be used to enforce a non-trivial solution, resulting to the convex program

$$\begin{matrix}\hat{x} = arg {min}_{x} {‖ x ‖}_{1} s . t . y = sign ( Ax ) \\ and & ( 5 ) \\ {y}^{T} ( Ax ) = 1. & \end{matrix}$$

This program enforces an l₁ norm constraint by exploiting the fact that y^{T}(Ax)=∥Ax∥₁ at the correct solution.

In the context of 1-bit CS, a condition similar to the RIP can be established by binary ε-Stable Embedding (BeSE). The BeSE guarantees the correctness of a sign-consistent reconstruction and characterizes the reconstruction error. The BeSE is in fact an angle embedding, which preserves the angles between signals, defined as

$${d}_{∠} ( x , {x}^{′} ) = \frac{1}{π} arc cos \frac{〈 x , {x}^{′} 〉}{{‖ x ‖}_{2} {‖ {x}^{′} ‖}_{2}} . \qquad ( 6 )$$

for two signals x and x′. The angle is preserved in the normalized Hamming distance between the measurements, defined as d_{H}(,′)=(Σᵢyᵢ⊕yᵢ′)/M, according to

d_{H}(y,y′)=(Σᵢyᵢ⊕yᵢ′)/M. (7)

Thus, if a signal with consistent measurements is found, i.e., d_{K}=0, then it is within angle ε of the measured signal. Similar to the RIP, the BeSE holds for measurement matrices with i.i.d. normal entries, although not in more general ensembles. Furthermore, successful signal recovery from 1-bit measurements with more general ensembles and without requiring the BeSE are also known.

### SUMMARY OF THE INVENTION

The embodiments of the invention provide a method for reconstructing signals from phase-only measurements using compressive sensing (CS). Specifically, the phase of linear complex measurements preserves information about phase angles of signals. This information is sufficient to reconstruct the signal within a positive scaling factor. Furthermore, the measurements contain sufficient information to formulate a convex program or a greedy process to recover the signal.

The phase of complex linear measurements of signals preserves significant information about the angles between the signals. The embodiments provide stable angle embedding guarantees, analogous to the restricted isometry property in conventional compressive sensing, which that characterizes how well the angle information is preserved.

A number of measurements, linear in the sparsity and logarithmic in the dimensionality of the signal, contains sufficient information to acquire and reconstruct a sparse signal within the positive scalar factor.

The reconstruction can be formulated and solved using conventional convex and greedy processes. Even though the theoretical results only provide approximate reconstruction guarantees, experiments suggest that exact reconstruction is possible.

### BRIEF DESCRIPTION OF THE DRAWINGS

FIG. 1 is a flow diagram of a method for reconstructing a signal according to embodiments of the invention;

FIG. 2 is a graph of average correlation of reconstructed signal with measured signal for various sparsity values; and

FIG. 3 is a graph of corresponding probability of correct support recovery in the reconstruction.

### DETAILED DESCRIPTION OF THE PREFERRED EMBODIMENTS

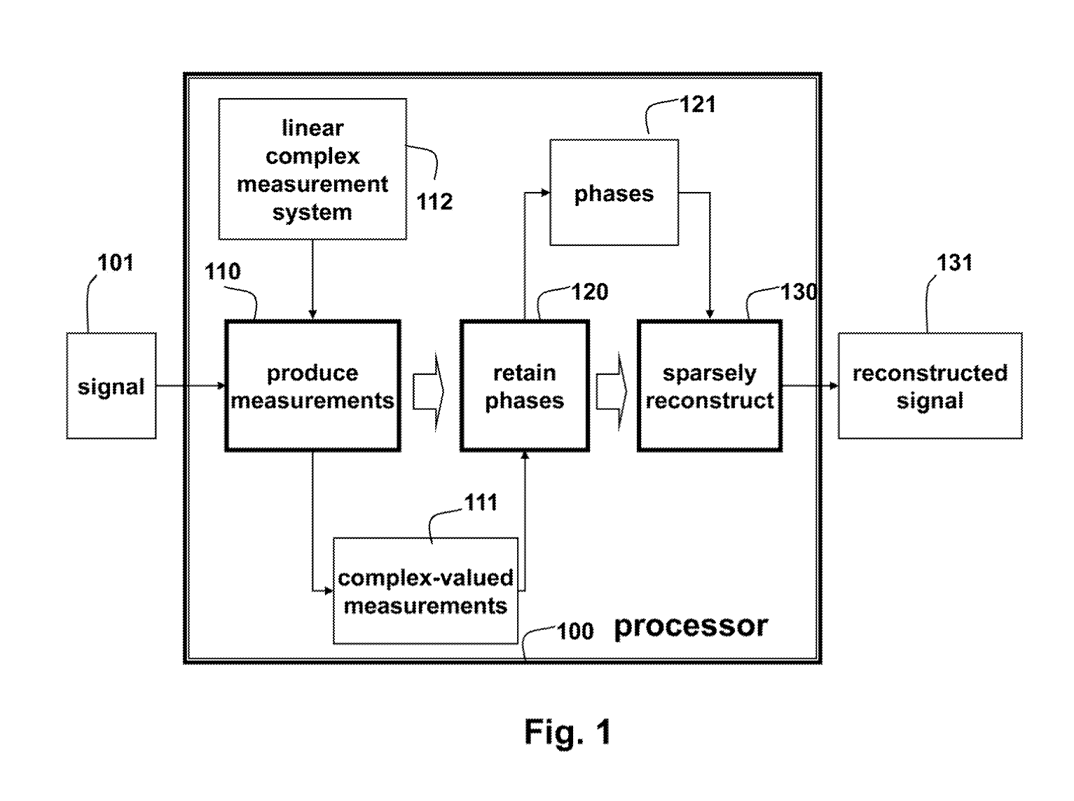

As shown in FIG. 1, embodiments of the invention provide a method for reconstructing signals from phase-only measurements using compressive sensing (CS). Complex-valued measurements 111 are produced 110 from a signal 101 by measuring the signal using a linear complex measurement system 112. Only phase 121 of the measurements are retained 120. Then, the signal 101 is reconstructed 130 as a reconstructed signal 131, within a positive scaling factor, using a sparse reconstruction method. The steps can be performed in a processor 100 connected to memory and input/output interfaces as known in the art.

The signal can be an electromagnetic signal in analog or digital from, e.g., a radio signal, radar signal, infrared signal, an optical signal, an x-ray signal, etc. The signal can also be an acoustic signal, such as a speech signal or an ultrasound signal.

Phase-Only Signal Acquisition

A linear acquisition model, i.e., the system 112, used by embodiments of the invention is

z=Ax, y=∠(z), (8)

where xε [symbol] ^{N} is a real signal, a matrix AεC^{M×N}, z represents linear measurement, ∠(•) denotes a principal angle of a complex number, applied element-wise to each vector coefficient, y represents the final phase measurements, and aₘ denotes the m^{th} row of A.

For any c>0, ∠(Ax)=φ(cAx), which means that angle measurements, similar to sign measurements in 1-bit CS, eliminate any norm information on x. Furthermore, if the acquisition matrix A only contains real elements, then the information in y is essentially the sign of the measurement, i.e., 0 and +π for positive and negative measurements, respectively. In that case, the problem reverts to 1-bit CS. Complex signals x can also be considered in this formulation.

Stable Angle Embedding

Similar to 1-bit sign measurements, phase measurements also provide a stable embedding. If two signals x and x′ are represented by a random Gaussian vector, the expected value E of the phase difference of the measurements is equal to

$$E \{ \vert ∠ ( \frac{{z}_{m}}{{z}_{m}^{′}} ) \vert \} = E \{ \vert ∠ ( {e}^{i ( {y}_{m} - {y}_{{m}^{′}} )} ) \vert \} = π {d}_{∠} ( x , {x}^{′} ) . \qquad ( 9 )$$

Thus, using Hoeffding's inequality and a simple concentration of measure argument, the following embedding property, similar to Johnson-Lindenstrauss (JL), embeddings exists.

Consider a finite set W⊂ [symbol] ^{N} of points measured using equation (8), with AεC^{M×N} consisting of i.i.d elements drawn from the conventional complex normal distribution. With probability greater than 1−2e^{2 log L-2ε}^{²}^{M} the following holds for all x, x′εC and corresponding measurements y, y′ε

[symbol]

$$\vert \frac{1}{M} {\sum }_{m}^{ } \vert \frac{1}{π} ∠ ( {e}^{i ( {y}_{m} - {y}_{{m}^{′}} )} ) \vert - {d}_{∠} ( x , {x}^{′} ) \vert \leq ɛ . \qquad ( 10 )$$

Furthermore, because the absolute value of the phase difference |φ(e^{i(y}^{ₘ}^{-y}^{_{m′}}⁾)| is Lipschitz continuous with Lipschitz constant equal to 1, this provides a continuous version of the embedding properties appropriate for sparse signals.

Consider the set S_{K}⊂ [symbol] ^{N} of all measured K-sparse signals in [symbol] ^{N}, as measured above. Equation (10) holds with probability greater than

$$1 - 2 {e}^{2 K log ( \frac{12 e }{ɛ} \frac{N}{K} ) - \frac{{ɛ}^{2} M}{2}} ,$$

for x and x′, and corresponding measurements y and y′.

The above suggest that, if the mean phase difference between the embedding of two signals relatively small, then the angle between these signals is also small. The above embedding properties are similar to the JL lemma, the RIP and the BeSE. The properties suggest that, similar to conventional CS, M=O(K log(N/K)) measurements are sufficient to acquire and reconstruct a signal. These guarantees can be extended to other structured signal and data sets, such as unions of subspaces or manifolds, using the Kolmogorov complexity of the set.

Unfortunately, the additive form of equation (10) does not guarantee exact reconstruction. Even if determine a sparse signal estimate \hat{x} with the same embedding as the measured signal x is determined, the above property can only guarantee that the signal within an angle ε from, i.e., |d_{∠}(x,\hat{x})|≦ε is identified. This behavior is similar to quantized embeddings, such as the BeSE, rather than continuous embeddings such as the RIP. Empirical results suggest that reconstruction is exact in practice and exact reconstruction guarantees should be possible.

Reconstruction

As described above, acquiring a signal using equation (8) eliminates all information on the magnitude of the signal. Thus, a reconstruction process, especially one based on l₁-norm minimization, should use a norm constraint to avoid trivial solutions. While ∥x∥²=1 seems like a natural constraint, that leads to a non-convex problem. Instead, the phase of each measurement is used to rotate that measurement to a positive real number. To do so, a vector of unit-magnitude complex coefficients, whose phase is equal to the phase of the measurements is defined using e^{iy}, i.e., (e^{iy})ₘ=e^{iy}^{ₘ}. Because e^{-iy}^{ₘ}zₘ=|zₘ|, it follows that (e^{iy})^{H}z=∥z∥₁, where (•)^{H} denotes the Hermitian (conjugate) transpose. Thus, the convex constraint (e^{iy})^{H}z=(e^{iy})^{H}Ax=1 can be used as a norm constraint to prevent the trivial solutions.

In addition to the norm constrain, the phase measurements of a solution should be the same as the original phase measurements. This means that when the linear measurements are properly rotated the measurements should produce positive real numbers: [symbol] {e^{-iy}^{ₘ}zₘ}≧0 and ℑ{e^{-iy}^{ₘ}zₘ}=0, where [symbol] {•} and ℑ{•}denotes the real and the imaginary part, respectively.

Combining all constraints the following program is obtained:

$$\hat{x} = {arg min}_{x} {‖ x ‖}_{0} \\ s . t . {( {e}^{i y} )}^{H} Ax = 1 , \\ \{ {e}^{- i {y}_{m}} 〈 {a}_{m} , x 〉 \} \geq 0 \\ and \\ 𝒥 \{ {e}^{- i {y}_{m}} 〈 {a}_{m} , x 〉 \} = 0. \qquad ( 11 )$$

Of course, this l₀ minimization can exhibit combinatorial complexity. Thus, in a preferred embodiment equation (11) can be relaxed to the convex program:

$$\hat{x} = {arg min}_{x} {‖ x ‖}_{1} \\ s . t . {( {e}^{i y} )}^{H} Ax = 1 , \\ \{ {e}^{- i {y}_{m}} 〈 {a}_{m} , x 〉 \} \geq 0 \\ and \\ 𝒥 \{ {e}^{- i {y}_{m}} 〈 {a}_{m} , x 〉 \} = 0. \qquad ( 12 )$$

Note that a rotated matrix Ã can be defined such that ãₘ=e^{-iy}^{ₘ}ãₘ, i.e., such that if the original signal was measured, positive real measurements would be produced. This means that the signal should be in the nullspace of the imaginary part of Ã. Furthermore, the constraint (e^{iy})^{H}Ax=1, above can be expressed using a linear combination of the rows of Ã: (1^{H}Ã)x=1, where 1 denotes a vector with all entries equal to 1.

Alternatively, a greedy process that attempts to find a sparse vector satisfying the constraints can be used. This is the approach in another preferred embodiment. The greedy process can solve the following optimization:

$$\hat{x} = arg {min}_{x} {‖ [ \begin{matrix}{( {e}^{- i y} )}^{H} A \\ 𝒥 \{ \tilde{A} \}\end{matrix} ] x - [ \begin{matrix}1 \\ 0\end{matrix} ] ‖}_{2}^{2} \\ s . t . {‖ x ‖}_{0} \leq K \\ and \\ \{ {e}^{- i {y}_{m}} 〈 {a}_{m} , x 〉 \} \geq 0. \qquad ( 13 )$$

This can be solved with straightforward modifications to conventional CS processes, such as Compressive Sampling Matched Pursuit (CoSaMP), iterative hard thresholding (IHT), or Algebraic Pursuit (ALPS), to incorporate the positivity constraint on the real part, in a manner similar to the constraints enforcing quantization.

However, the positivity constraint does not seem to contribute significantly to the performance of the system and thus can be ignored. In this case, the program can be solved using known processes without any modification. Because a number of implementations of those process expect real matrices as inputs, the complex constraint (e^{iy})^{H}A=1 can be implemented as two real constraints [symbol] {(e^{iy})^{H}A}x=1 and ℑ{(eⁱ)^{H}A}x=0. Similarly for the part of the cost function enforcing that constraint in equation (13).

In summary, the phase of complex measurements contains sufficient information to fully reconstruct a sparse signal within a scaling factor, and that two sparse signals with similar measurements also have very high correlation.

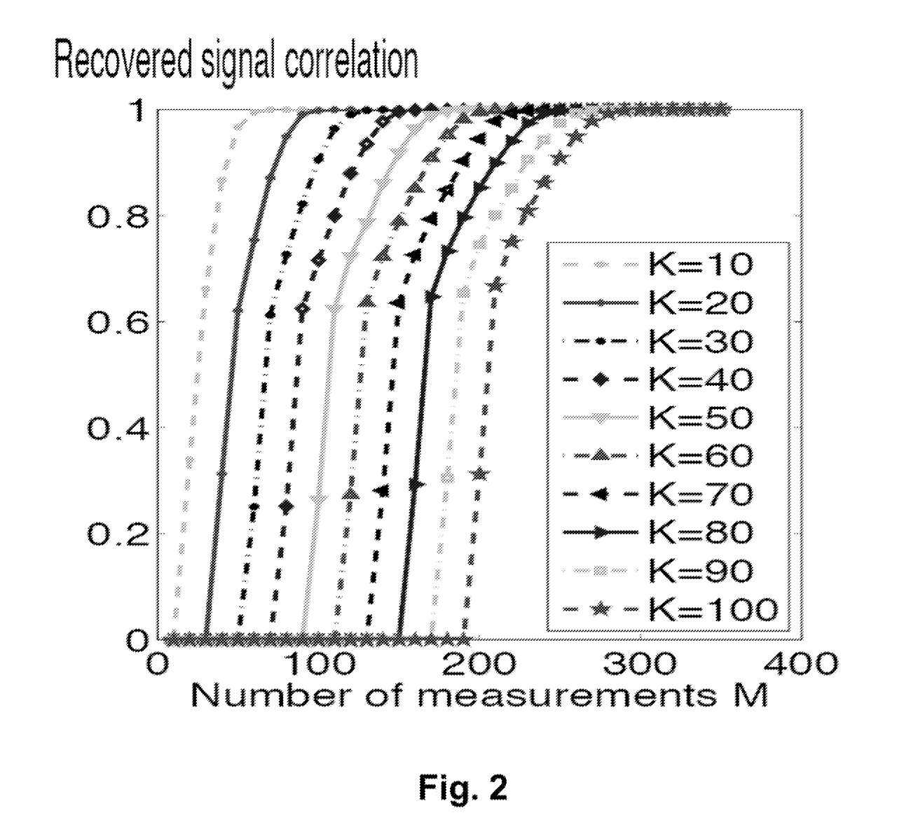

FIG. 2 shows the average correlation of reconstructed signal with measured signal for various sparsity values, i.e., the number of non-zero coefficients, K.

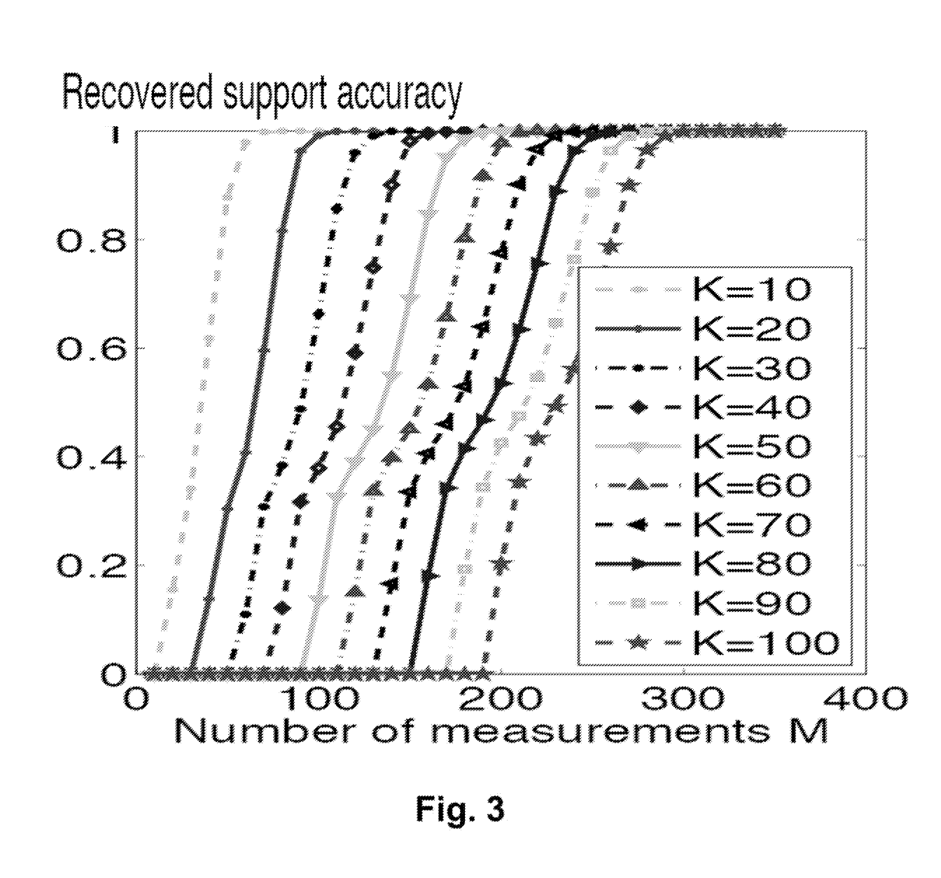

FIG. 3 shows the corresponding probability of correct support recovery in the reconstruction.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for reconstructing a signal, comprising the steps of:
producing complex-valued measurements of the signal by measuring the signal using a linear complex measurement system;
retaining only a phase of the complex-valued measurements; and
reconstructing the signal from the phase of the complex measurements within a scaling factor using a sparse reconstruction method, wherein the steps are performed in a processor.

2. The method in claim 1, wherein the signal is real.

3. The method in claim 1, wherein the signal is complex.

4. The method in claim 1, wherein the phase is quantized.

5. The method in claim 1, wherein the sparse reconstruction method is a convex optimization.

6. The method in claim 1, wherein the sparse reconstruction method is a greedy process.

7. The method in claim 1, wherein the sparse reconstruction method produces the phase of the reconstructed signal are similar to the phases of the signal.

8. The method in claim 1, wherein the sparse reconstruction method uses a linear system rotated according to the phase.

9. The method in claim 8, wherein the sparse reconstruction method enforces that the reconstructed signal produces real measurements when measured with the rotated linear system.

10. The method in claim 8, wherein the sparse reconstruction method enforces that the reconstructed signal produces zero measurements when measured with an imaginary part of the rotated linear system.

11. The method in claim 9, further comprising:
enforcing that the real measurements are positive by the sparse reconstruction method.

12. The method in claim 11, wherein the enforcing uses a convex cost function.

13. The method in claim 8, wherein the sparse reconstruction method uses a linear combination of the rotated linear system.

14. The method in claim 13, wherein the sparse reconstruction enforces that the measurements obtained by the linear combination of the rotated system produces a fixed constant.

15. The method in claim 1, wherein the linear complex measurement system is described by a random matrix.

16. The method in claim 15, wherein the random matrix comprises of independent and identically distributed elements.

17. The method in claim 16, wherein the elements are generated with a complex normal distribution.

18. The method in claim 15 wherein the random matrix is a subsampled Fourier matrix.

19. The method in claim 1, wherein the signal measured is a radio wave.

20. The method in claim 1, wherein the signal measured is an acoustic wave.

21. The method in claim 1 wherein the signal measured is a light field.
